(19) United States
(12) Patent Application Publication
(10) Pub. No.: US 2014/0238116 A1
(43) Pub. Date: Aug. 28, 2014

(54) ULTRASONIC SYSTEM FOR MEASURING BOTH FLOW RATE AND CONCENTRATION

(71) Applicant: WESS GLOBAL, INC., Chungcheongnam-do (KR)

(72) Inventors: Nam Won Kwan, Chungcheongnam-do (KR); In Soo Kim, Chungcheongnam-do (KR); Jin Woo Kim, Chungcheongnam-do (KR); Jong Seop Park, Chungcheongnam-do (KR)

(73) Assignee: WESS GLOBAL, INC., Chungcheongnam-do (KR)

(21) Appl. No.: 14/349,818

(22) PCT Filed: Sep. 20, 2012
(86) PCT No.: PCT/KR2012/007531

§ 371 Date: Apr. 4, 2014

(30) Foreign Application Priority Data
Oct. 6, 2011 (KR) 10-2011-0101566

(51) Int. Cl. G01N 29/02; G01F 1/66

(52) U.S. Cl. CPC G01N 29/02; G01F 1/667
USPC 73/61.79

(57) ABSTRACT

Disclosed is an ultrasonic system for measuring both a flow rate and a concentration including: a transmission ultrasonic sensor which is attached to an outer wall of a pipe and which transmits an ultrasonic signal, a concentration-metering ultrasonic sensor which is attached to the opposite outer wall of the pipe and receives the ultrasonic signal that has passed through the wall of the pipe, flow-metering sensors which are attached to the opposite wall of the pipe and receive ultrasonic signals transmitted by the transmission ultrasonic sensor at different points in time, and a unified signal processor which measures a concentration and a total amount of suspended solids according to the intensities of the ultrasonic signals received by the sensors, and measures a flow rate of a fluid using a difference in transit time through a medium.

### TECHNICAL FIELD

The present invention relates to an ultrasonic system for measuring both a flow rate and a concentration, and more particularly to an ultrasonic system for measuring both a flow rate and a concentration, which can measure a flow rate of water to be subject to treatment of some sort; and a concentration and a total amount of suspended solids contained in the water to be treated.

### BACKGROUND ART

Generally, an ultrasonic concentration meter is a measuring instrument which measures the concentration of various kinds of sludge, in real time, either which flow along with a fluid through a pipe, or which settle in many types of waterworks plants, such as a water purification plant, a water treatment plant, or a sewage treatment plant.

FIGS. 1(a) and 1(b) are diagrams illustrating the structure of an ultrasonic concentration meter inserted in a pipe according to a conventional art.

As illustrated in FIGS. 1(a) and 1(b), a conventional ultrasonic concentration meter 10 is inserted in a pipe 1. An ultrasonic signal radiated from an ultrasonic transmission sensor 11 attenuates by being scattered or absorbed by impurities, foreign substances, suspended solids, etc. contained in a fluid (sample solution) while passing through the fluid, and then reaches an ultrasonic reception sensor 12. The concentration of a substance in the fluid is measured according to the intensity of the received ultrasonic signal.

The conventional ultrasonic concentration meter 10 has a problem that, when removing the ultrasonic transmission sensor 11 and the ultrasonic reception sensor 12 from the ultrasonic concentration meter 10 for the purpose of maintenance (i.e. replacement or cleaning of the sensors), the stream of the fluid is adjusted to bypass the ultrasonic concentration meter 10 by closing valves installed at an inlet and an outlet of the ultrasonic concentration meter 10, respectively and by opening a bypass valve, and then replacement of the sensors can be carried out thereafter.

Accordingly, the conventional ultrasonic concentration meter 10 needs to be additionally equipped with a bypass pipeline and a bypass valve, which increases installation cost and imposes a limitation on the size of an installation space.

Furthermore, since the entire surfaces of the ultrasonic transmission sensor 11 and the ultrasonic reception sensor 12 are constantly in contact with the fluid which is flowing through the inside of the ultrasonic concentration meter, sludge is likely to stick to the surfaces of the ultrasonic transmission sensor 11 and the ultrasonic reception sensor 12 depending on kinds and characteristics of the suspended solids contained in the fluid when the fluid flows at a low velocity a for a long period of time or when the concentration of the suspended solids in the fluid is excessively high. The sludge sticking to the sensors deteriorates the sensitivity of the sensors. For this reason, the conventional ultrasonic concentration meter presents the problem that the sensors need to be periodically cleaned.

That is, since the fluid, a measurement subject, contains various kinds of pollutants as well as suspended solids which are targets for concentration measurement, there is a high possibility that the ultrasonic transmission sensor 11 and the ultrasonic reception sensor 12 will break down if not cleaned.

FIG. 2 is a diagram illustrating the structure of an ultrasonic transit-time liquid flow meter according to a conventional art, and FIGS. 3(a) through 3(c) are diagrams illustrating signal paths of ultrasonic transit-time liquid flow meters according to convention arts.

With reference to FIG. 2, the ultrasonic transit-time liquid flow meter according to the convention art is structured and operated in the following manner: a pair of ultrasonic sensors 13 and 14 are installed to face both opposite walls of a pipe 1 and to have a predetermined angle with respect to the direction of flow in the pipe 1; an ultrasonic signal is repeatedly transmitted and received between the upstream-side ultrasonic sensor 13 and the downstream-side ultrasonic sensor 14; the velocity of a fluid is obtained using a difference in transit time between the ultrasonic signals, and the velocity is converted into a volume rate of flow.

Generally, an ultrasonic transit-time flow meter, which measures a flow rate using a time difference in transit time, has the structure described below, and the flow rate is calculated as follows.

A down-transit time t_{dn}, a time, that takes for an ultrasonic signal transmitted by the upstream ultrasonic sensor 13 to pass through the liquid and reach the downstream ultrasonic sensor 14, and an up-transit time tᵤₚ, a time, that takes for the ultrasonic signal to travel in the reverse direction are measured, and a flow rate is calculated using these transit times.

The relations between the up-transit time tᵤₚ and the down-transit time t_{dn} for a case where there is flow of a fluid in a pipe and for a case where there is no flow of a fluid in a pipe are obtained from the following Equation 1.

$${t}_{up} = \frac{P}{C} \\ {t}_{up} = \frac{P}{C - V sin θ} \\ {t}_{dn} = \frac{P}{C} \\ {t}_{dn} = \frac{P}{C + V sin θ} \\ Δ t = {t}_{up} - {t}_{dn} = 0 \\ 〈 for a case where there is no flow , V = 0 〉 \\ Δ t = {t}_{up} - {t}_{dn} \\ 〈 for a case where there is flow , V \neq 0 〉 \qquad 〈 Equation 1 〉$$

Wherein, tᵤₚ is an upward transit time, t_{dn} is a downward time, V is a flow velocity, c is a sound velocity, t is a time difference, P is the path length of an ultrasonic signal, a is an axial length, θ is the angle of an ultrasonic sensor (an angle between the path of an ultrasonic signal and the direction of flow)

When there is the flow in the pipe, the relations between the flow velocity v and the transit time tᵤₚ or t_{dn} are represented by the following Equation 2.

$$V = \frac{{P}^{2}}{2 L} ( \frac{1}{{t}_{dn}} - \frac{1}{{t}_{up}} ) = \frac{{P}^{2}}{2 L} ( \frac{{t}_{up} - {t}_{dn}}{{t}_{dn} \times {t}_{up}} ) \qquad 〈 Equation 2 〉$$

The flow velocity obtained using Equation 2 is multiplied by the cross-section area of the pipe, through which the fluid flows, producing a volume rate of flow according to Equation 3.

Q=V×A <Equation 3>

In Equation 3, A is the cross-section area of the pipe.

As described above, the measurement principle of the ultrasonic transit-time liquid flow meter according to the conventional art can be applied to any type (inserted-type or clamp-on type) of sensors 13 and 14 for measurement.

In a method of measuring a time difference between the up-transit time and the down-transit time using the conventional ultrasonic transit-time liquid flow meter, the path of the ultrasonic signal varies depending on the arrangement of the sensors 13 and 14 in the pipe as illustrated in FIGS. 3(a) to 3(c). Generally, the path of an ultrasonic signal is determined by taking into account the material/size of a pipe and the characteristics of a fluid.

Currently, measurement of a concentration and a total amount of suspended solids (SS) of various kinds of sludge (raw sludge, thickened sludge, return sludge and excess sludge) and measurement of a flow rate of waste water that contains SS are carried out by using both of an ultrasonic liquid flow meter and an inserted-type ultrasonic concentration meter.

Here, SS refers to foreign substances either which are generated during water treatment or which exist in raw water and is a factor to determine the quality of water.

Measurements obtained by using a combination of the ultrasonic liquid flow meter and the inserted-type ultrasonic concentration meter are limited to only a flow rate of wastewater and a concentration of SS contained in the wastewater. Furthermore, since the measurement instruments are manufactured or supplied by many different benders or manufacturers, maintenance of the measurement instruments are not easy.

In addition, other problems are also found during post treatment, such as transfer and dehydration of sludge, in which the concentration of SS (i.e. measurement target) and the flow rate of wastewater are measured and the sludge is treated. That is, in many plants for post treatment, it is a common practice that a pump and a dehydrator with extra capacity is installed, without knowing the total amount of SS.

Accordingly, there is a demand for a measurement instrument which can simultaneously measure a flow rate of water to be treated and a concentration and a total amount of suspended solids contained in the water to be treated, for wastewater treatment. The development of such an instrument enables quantitative management of sludge which is a byproduct of water treatment and is considered an alternative energy source to substitute for fossil fuels.

### DISCLOSURE

### Technical Problem

Accordingly, the present invention has been made keeping in mind the above problems occurring in the prior art, and an object of the present invention is to provide an ultrasonic system for measuring both a flow rate and a concentration, which has the following advantages: (A) it can quantitatively manage sludge which is a byproduct of water treatment using a sensor and a sensor-fixing structure, the sensor being capable of simultaneously measuring a flow rate of water to be treated and a concentration and a total amount of suspended solids in the water to be treated; (B) it can determine optimum capacity and maximize efficiency of a dehydrator and a pump, which are post treatment equipment, by measuring a total amount of suspended solids; and (C) it can maximize process operation efficiency and contribute to saving of maintenance costs and to prevention of excessive investment in equipment by developing a complex machine in which functions of a concentration meter and a flow meter are unified.

### Technical Solution

In order to accomplish the above object(s), the present invention provides an ultrasonic system for measuring both a flow meter and a concentration, including: a transmission ultrasonic sensor that transmits an ultrasonic signal to pass through a wall of a pipe and that is attached to an outer surface of the wall of the pipe through which a fluid, a measurement subject, flows; a concentration-metering ultrasonic sensor that receives the ultrasonic signal, which is transmitted from the transmission ultrasonic sensor and which passes through the fluid and the wall of the pipe; a flow-metering ultrasonic sensor that receives ultrasonic signals, which are transmitted from the transmission ultrasonic sensor, at different points in time; and a unified signal processor that measures a concentration and or a total amount of SS according to intensities of the ultrasonic sensors received by the concentration-metering ultrasonic sensor and the flow-metering ultrasonic sensor, and measures a flow rate by using a time difference in transit time through a medium.

The flow-metering ultrasonic sensor may include three sensors so that the ultrasonic signal can travel along a double Z-path.

The unified signal processor may include: an operation switch which is operated for measurement of a concentration and a flow rate, for setting of menu, or outputting of a measurement result; a sensor transception portion that enables high power transmission and high gain reception of a signal by amplifying ultrasonic signals transmitted and received by the transmission ultrasonic sensor, the concentration-metering ultrasonic sensor, and the flow-metering ultrasonic sensor; a control portion that is mounted with a flow-metering algorithm and a Process Condition Monitoring (PCM) algorithm in order to execute a flow rate and concentration measurement mode suited for a field, to determine whether a process is normally running or not, and to perform operation and control related to measurement of a flow rate and a concentration; a power supply portion that supplies power needed by the control portion and the sensor transception portion; and an external output portion that outputs a concentration measured through the control portion to an external device.

The external output portion may be connected to at least one external output unit selected from among a display output unit, a relay output unit, and an LED

The PCM algorithm may check a process state, a pipe state, and a dispersion uniformity of SS, determines “run” or “stop” as a process operation state by collating results of the checking, and notify an operator of information about measurement of in-process effective SS, the process operation state, and a pipe filling state (“full” or “empty”) by determining the dispersion uniformity of SS.

The PCM algorithm may perform measurement modes including a Real Time (RT) mode in which a change in concentration is measured in real time according to an on-site operation pattern and a Process Monitoring (PM) mode in which a change in concentration is automatically measured only while a process is running, based on a result of PCM.

The unified signal processor may further have an RF transmission function to enable telemetering.

The flow-metering ultrasonic sensor may be embodied into a module by using a dedicated transit-time(dT)-metering chip.

### Advantageous Effects

According to the ultrasonic system for measuring both a flow rate and a concentration described above, as employing a sensor and sensor-fixing structure, the sensor being capable of simultaneously measure a flow rate of water to be treated and a concentration and a total amount of suspended solids in the water to be treated, the ultrasonic system is a complex machine in which functions of a concentration meter and a flow meter are unified. The ultrasonic system can quantitatively manage sludge which is a byproduct from a water treatment process, can maximize process operation efficiency of water treatment by performing control on post treatment and determining optimum load according to the total amount of suspended solids (SS), can reduce labor cost by enabling single-operator process control, and enable conversion of a control pattern from conventional passive process control to active process control.

In addition, with the functions of a concentration meter and a flow meter being unified, comprehensive market infiltration and revenue maximization are possible, cost including operation cost for water treatment, maintenance cost, and labor cost can be reduced, the technology of water treatment can be qualitatively improved; and water quality environment can also be improved.

### DESCRIPTION OF DRAWINGS

FIGS. 1(a) and 1(b) are diagrams illustrating the structure of an ultrasonic concentration meter inserted in a pipe according to a conventional art;

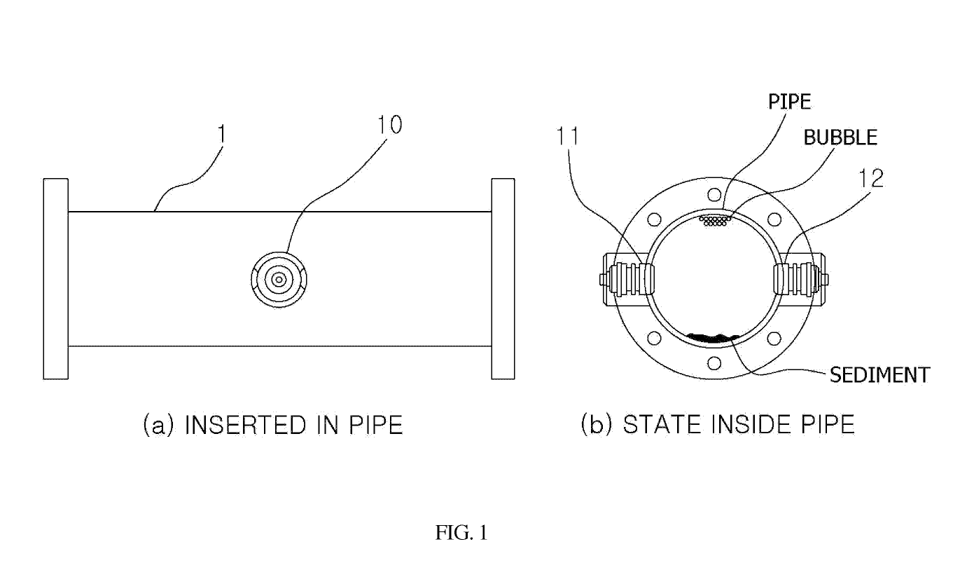

FIG. 2 is a diagram illustrating the structure of an ultrasonic transit-time liquid flow meter according to a conventional art;

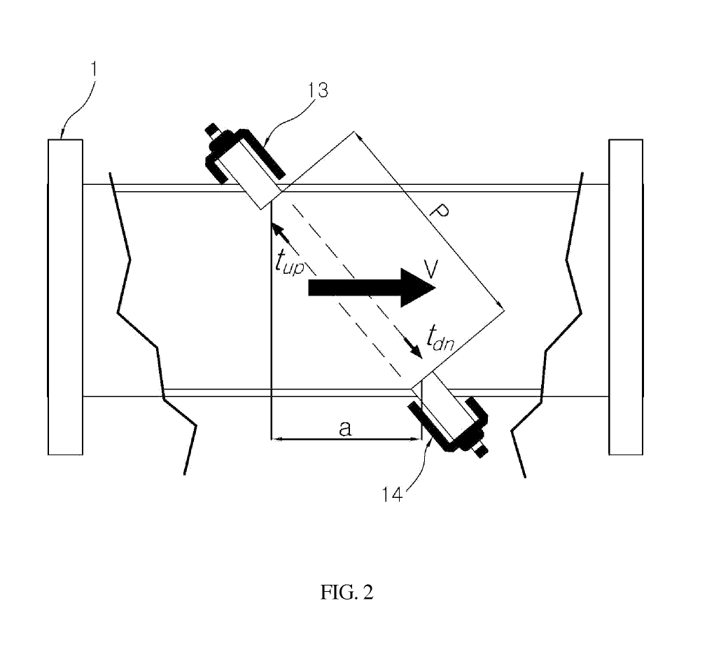

FIGS. 3(a) through 3(c) are diagrams illustrating various signal paths of conventional ultrasonic transit-time liquid flow meters;

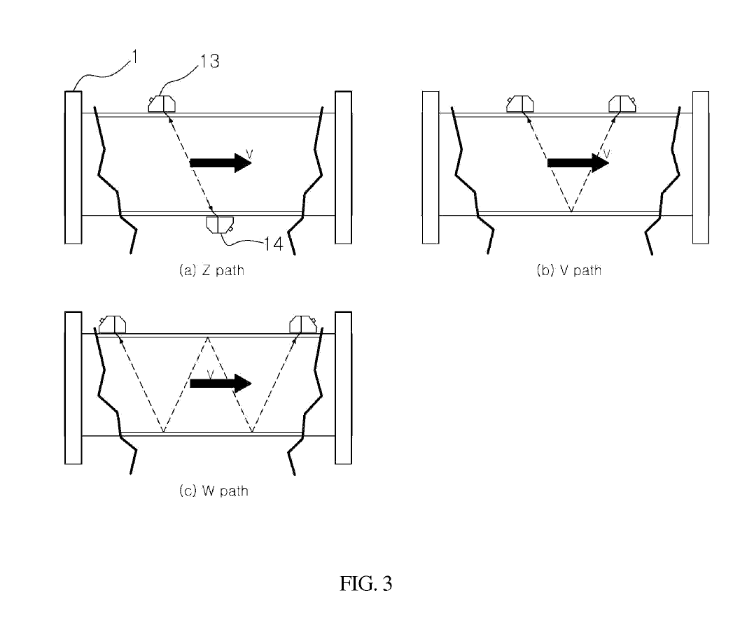

FIG. 4 is a diagram illustrating the overall structure of an ultrasonic system for measuring both a flow meter and a concentration according to one embodiment of the present invention;

FIG. 5 is a diagram illustrating a signal path of an ultrasonic transit-time liquid flow meter according to one embodiment of the present invention;

FIG. 6 is a diagram illustrating an arrangement of sensors according to one embodiment of the present invention; and

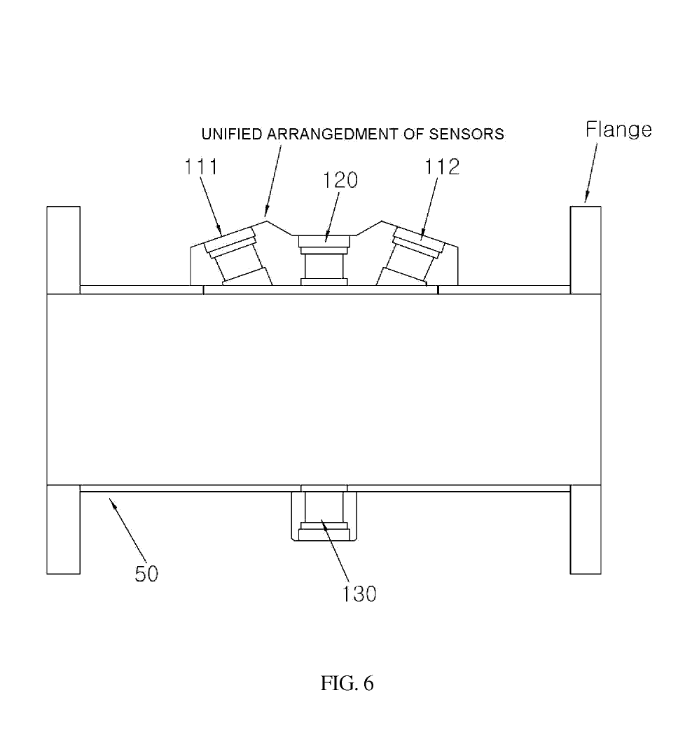

FIG. 7 is a block diagram illustrating the internal structure of a unified signal processor according to one embodiment of the present invention.

<Description of the Reference Numerals in the Drawings>

| | |
|---|---|
| 50: Pipe | |
| 111, 112: Flow-metering ultrasonic sensor | |
| 120: Concentration-metering sensor | |
| 130: Transmission ultrasonic sensor | |
| 200: Unified signal processor | |
| 210: Sensor transception portion | |
| 220: Control portion | 230: Power supply portion |
| 240: Data storage portion | |
| 250: External output portion | |
| 260: Display means | 270: LEDs |
| 280: Relay | |

### MODE FOR INVENTION

Reference will now be made in detail to various embodiments of the present invention, specific examples of which are illustrated in the accompanying drawings and described below, since the embodiments of the present invention can be variously modified in many different forms. While the present invention will be described in conjunction with exemplary embodiments thereof, it is to be understood that the present description is not intended to limit the present invention to those exemplary embodiments. On the contrary, the present invention is intended to cover not only the exemplary embodiments, but also various alternatives, modifications, equivalents and other embodiments that may be included within the spirit and scope of the present invention as defined by the appended claims. When describing the drawings, the same reference numerals are used throughout the different drawings to designate the same or similar components.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, preferred embodiments of the present invention will be described in greater detail with reference to the accompanying drawings.

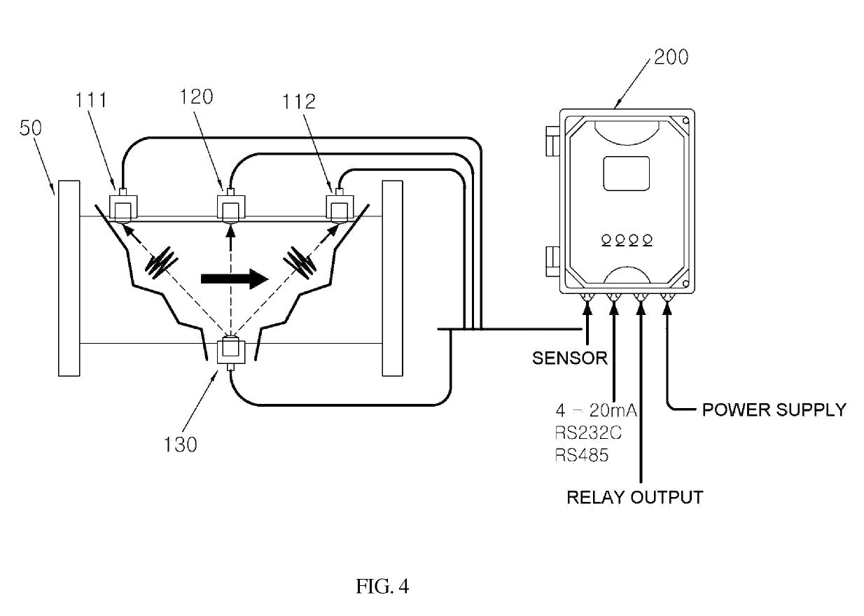

With reference to FIG. 4, an ultrasonic system for measuring both a flow rate and a concentration according to one embodiment of the present invention includes: a transmission ultrasonic sensor 130 which is attached to an outer wall of a pipe 50, through which a fluid to be measured flows, and which transmits an ultrasonic signal through the wall of the pipe 50; a concentration-metering ultrasonic sensor 120 which is attached to the opposite outer wall of the pipe 50 and receives the ultrasonic signal, which has passed through the wall of the pipe 50 after being transmitted by the transmission ultrasonic sensor 130; flow-metering sensors 111 and 112 which are attached to the opposite wall of the pipe 50 and receive ultrasonic signals transmitted by the transmission ultrasonic sensor 130 at different points in time; and a unified signal processor 200 which measures a concentration and a total amount of suspended solids (SS) according to the intensities of the ultrasonic signals received by the concentration-metering ultrasonic sensor 120 and the flow-metering ultrasonic sensors 111 and 112, and measures a flow rate of a fluid using a difference in transit time of the ultrasonic signal through a medium.

A general ultrasonic sensor uses a PZT piezoelectric element to measure a physical quantity in the air or under water. However, as to the ultrasonic sensors 111, 112, 120, and 130 which are clamp-on type, since the ultrasonic signal transmitted from the transmission ultrasonic sensor 130 passes sequentially through the wall of the pipe 50, the fluid to be measured, and the wall of the pipe 50, and then reaches the concentration-metering sensor 12 and the flow-metering sensors 111 and 112, many different materials can form the path of the ultrasonic signal. Furthermore, since the signal significantly attenuates while passing along each signal path, it is necessary to use a high sensitivity or high performance piezoelectric element for reliable measurement or it is needed to increase the sensitivity of the sensor transception portion 210.

A mounting structure for securing the ultrasonic sensors 111, 112, 120, and 130, needs to be stably installed on the pipe 50 to ensure reliability of measurement. The mounting structure also needs to be easily installed and shifted, to shield the sensors from external noise, and to have a waterproof design.

In particular, the concentration-metering ultrasonic sensor 120 can expand its concentration measurement range by 20% by using a superposition method.

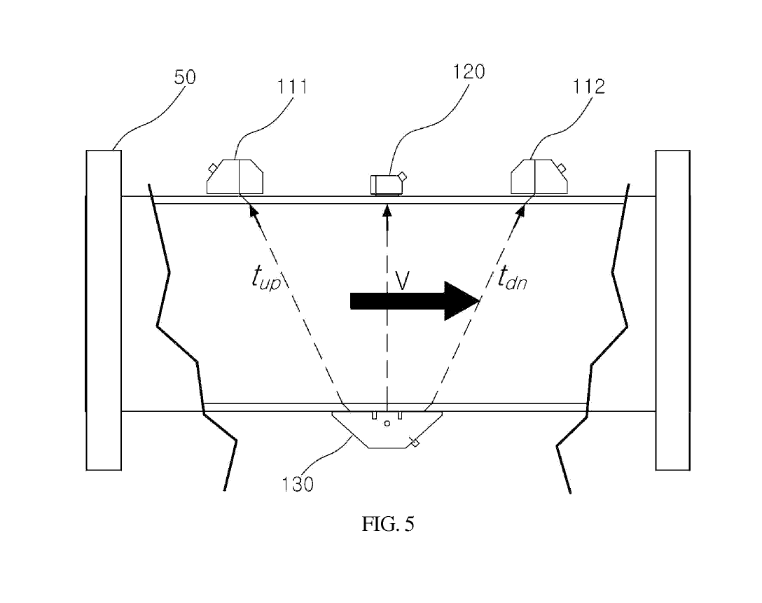

As shown in FIG. 5, the flow-metering ultrasonic sensors 111 and 112 are made up of two sensors 111 and 112 so that a double Z-path modified from a Z-path or a V-path, which has been conventionally used, is formed as the path of the ultrasonic signal.

Accordingly, unlike a conventional ultrasonic flow meter, the flow-metering sensors 111 and 112 are dedicated sensors that are exclusively used for reception of a signal. They can reduce a measurement error attributable to sensors' characteristics such as ringing, and perform one-shot measurement by having the double Z-path. Furthermore, they enable monitoring and diagnosing of abnormal process conditions and sensors' malfunctioning. Moreover, since transmission and reception of a signal are performed by different dedicated sensors, a time-keeping circuit can be simplified, measurement reliability can be improved, and measurement items can be diversely selected like concentration, flow rate, or a combination of concentration and flow rate.

In addition, the flow-metering ultrasonic sensors 111 and 112 are applied to the pipe 50 which employs an STMR( ). So, the sensors can be easily arranged, attached, and maintained. With the unified arrangement of the reception sensors (flow-metering ultrasonic sensors 111 and 112), reproducibility of transmit-time measurement is maximized.

Furthermore, for the flow-metering ultrasonic sensors 111 and 112, a dT (transit-time)-metering module uses a dedicated dT (transit-time)-metering chip for the purpose of realization of a compact and lightweight body. Accordingly, a flow-metering circuit can be simplified and the transit time can be measured in the unit of ps.

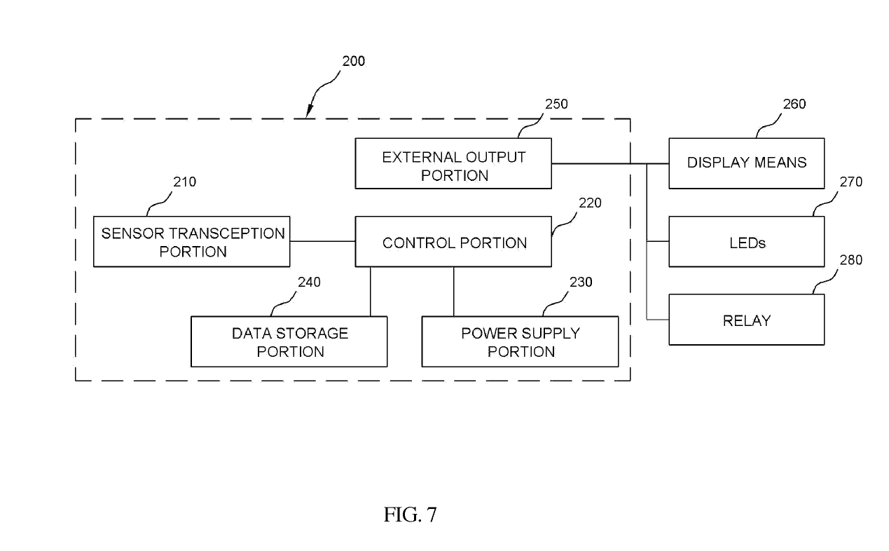

As illustrated in FIG. 7, the unified signal processor 200 includes, but is not limited to, operation switches (not shown), a sensor transception portion 210, a control portion 220, a power supply portion, and an external output portion. The operation switches (not shown) are operated for operation of equipment during measurement of a concentration and a flow rate, for setting of menu, and for outputting of results. The sensor transception portion 210 amplifies the ultrasonic signal transmitted or received by the ultrasonic sensors 111, 112, 120, and 130, thereby performing high power transmission and high gain reception of the ultrasonic signal. The control portion 220 is mounted with a flow-metering algorithm and a Process Condition Monitoring (PCM) algorithm, thereby performing optimum modes for measuring a flow rate and a concentration suited for the field, determining whether a process is normal or not, and performing operation and control related to measurement of a flow rate and a concentration. The power supply portion 230 supplies power needed by the control portion 220 and the sensor transception 210. The external output unit 250 outputs measurements of a concentration to an external device through the control portion.

The unified signal processor 200 has an RF transmission function to enable telemetering, a signal amplification function to amplify and filter signals transmitted or received by the ultrasonic sensors 111, 112, 120, and 130, and a data logging function to store data of measurements as much as data obtained over the course of up to 400 days in the data storage portion 240.

In addition to the flow-metering algorithm and the PCM algorithm, the control portion 220 is further mounted with an Envelope Energy Average Method (EEAM) to quantitative the received signal.

The external output portion 250 is connected to at least any one of a display means 260; such as a thin film transistor (TFT) color LCD or a touch screen; LEDs 270, and a relay 280 so that data can be processed into one output form (analog form, digital form, or relay form) desired by a user.

The control portion 220 measures a flow rate using the flow-metering algorithm and a concentration using the PCM algorithm. The flow-metering algorithm interlocks with the PCM algorithm, enabling precise and accurate diagnosis.

The PCM algorithm checks a process state, a pipe state, and a dispersion uniformity of SS, and then determines a process operation state (“run” or “stop”) by collating results of the checking, and notifies an operator of information about concentration measurement of effective SS during the operation of a process, about the process operation state, and about a pipe filling state (“full” or “empty”), based on the dispersion uniformity of the SS.

The PCM algorithm has measurement modes including a Real Time (RT) mode in which a change in concentration is monitored in real time according to an on-site operation pattern and a Process Monitoring (PM) mode in which a change in concentration is automatically measured only while the process is running, based on a result of the process condition monitoring (PCM).

Accordingly, the PCM algorithm verifies currently obtained measurements by filtering an ultrasonic signal and a temperature signal, which are received, using various filters, and selectively uses only those measurements which meet the standards. In this way, adequate concentrations for the actual process state are obtained, and reliability and stability of a product can be maximized.

Hereinafter, the operation of the ultrasonic system for measuring both a flow rate and a concentration according to the embodiment of the present invention will be described in greater detail with reference to the drawings.

The ultrasonic system for measuring both a flow rate and a concentration according to the embodiment of the present invention is applied to a manufacturing process or a raw material treatment process in which SS and liquid are mixed or to the field which uses a combination of a flow meter and a concentration meter. So, the ultrasonic system executes the function of measuring a concentration (%, ppm, mg/l, g/l, etc.), the function of measuring a flow rate of a SS-mixed fluid, and the function of measuring a net amount of SS or a total amount of SS contained in the flow.

In this case, by using the function of measuring the total amount of SS, it is possible to quantitatively calculate the amount of generated sludge which is a byproduct from a water treatment process using Equation 4.

SS=Q×SS % <Equation 4>

Wherein, SS is amount of sludge, Q is measured flow rate, and SS % is measured concentration.

For example, when a process flow rate which is presently measured is 100 m³/hr and when the value of the measured concentration is 2%, the amount of sludge is calculated from Equation 5 and Equation 4.

$$\begin{matrix}SS = 100 ( {m}^{3} \text{/} hr ) \times 2 \% \\ = 100 \times 10000 ( mg \text{/} l ) \\ = 100 \times 10 ( g \text{/} l ) \\ = 100 \times {10}^{6} ( {cm}^{3} \text{/} hr ) \times 10 ( g \text{/} l ) \\ = 100 \times {10}^{3} ( l \text{/} hr ) \times 10 ( g \text{/} l ) \\ = 100 \times {10}^{3} ( l \text{/} hr ) \times 0.01 ( kg \text{/} l ) \\ = 1000 ( kg \text{/} hr )\end{matrix} \qquad 〈 Equation 5 〉$$

When an operator performs flow rate measurement, the flow-metering ultrasonic sensors 111 and 112 receive the ultrasonic signals, which are transmitted by the transmission ultrasonic sensor 130 along a double Z-path, using a difference in transit time of a signal through a medium, and the control portion 220 of the unified signal processor 200 calculates a flow rate by executing the flow-metering algorithm, on the basis of the signal which is input through the sensor transception portion 210.

When an operator performs concentration measurement, the concentration-metering ultrasonic sensor 120 receives the ultrasonic signal which traveled passing through the wall and transfers it to the control portion 220 of the sensor transception portion 210, and the control portion 220 calculates the concentration and total amount of SS by executing the PCM algorithm.

The PCM algorithm may interlock with the flow-metering algorithm and measures a reliable concentration needed in the plant by determining the pipe filling state (empty or full) and by measuring a concentration only while the process is running.

In this way, the concentration, the flow rate, and the combination of the concentration and flow rate needed in the plant can be obtained using a single signal processor 200, and the concentration and total amount of SS and the flow rate of water to be treated are calculated based on the ultrasonic signals received by the ultrasonic sensors 111, 112, and 120.

Various physical quantities can be measured by simply changing the arrangement of the ultrasonic sensors 111, 112, 120, and 130.

The ultrasonic system for measuring both a flow rate and a concentration according to the embodiment of the present invention can be applied to all the fields which use both a liquid flow meter and a concentration meter. Specifically, it can be applied to the field of water treatment in which sludge is generated, returned, and treated, the field of petroleum refinement and chemical treatment in which a desulfurization process or a waste decomposition process are performed, the field of beverage and food processing in which raw materials of beverages and food are inspected and processed and food waste is decomposed, the field of construction in which the quality of wastewater of ready-mixed concrete industry which is primarily treated is checked, and the field of pharmacy in which raw materials are inspected.

Although a preferred embodiment of the present invention has been described for illustrative purposes, those skilled in the art will appreciate that various modifications, additions and substitutions are possible, without departing from the scope and spirit of the invention as disclosed in the accompanying claims.

### INDUSTRIAL APPLICABILITY

The present invention relates to an ultrasonic system for measuring both a flow rate and a concentration, and more particularly to an ultrasonic system for measuring both a flow rate and a concentration, which can simultaneously meter a flow rate of water to be treated, and a concentration and a total amount of suspended solids contained in the water to be treated using a sensor fixing structure, which is a complex machine of a sensor fixing structure, and a unified signal processor.

1. An ultrasonic system for measuring both a flow rate and a concentration, comprising:
a transmission ultrasonic sensor that transmits an ultrasonic signal to pass through a wall of a pipe and that is attached to an outer surface of the wall of the pipe through which a fluid, a measurement subject, flows;
a concentration-metering ultrasonic sensor that receives the ultrasonic signal, which is transmitted from the transmission ultrasonic sensor and which passes through the fluid and the wall of the pipe;
a flow-metering ultrasonic sensor that receives ultrasonic signals, which are transmitted from the transmission ultrasonic sensor, at different points in time; and
a unified signal processor that measures a concentration and or a total amount of SS according to intensities of the ultrasonic sensors received by the concentration-metering ultrasonic sensor and the flow-metering ultrasonic sensor, and measures a flow rate by using a time difference in transit time through a medium and,
wherein the flow-metering ultrasonic sensor comprises three sensors so that the ultrasonic signal travels along a double Z-path and,
wherein the unified signal processor comprises:
an operation switch which is operated for measurement of a concentration and a flow rate, for setting of menu, or outputting of a measurement result;
a sensor transception portion that enables high power transmission and high gain reception of a signal by amplifying ultrasonic signals transmitted and received by the transmission ultrasonic sensor, the concentration-metering ultrasonic sensor, and the flow-metering ultrasonic sensor;
a control portion that is provided with a flow-metering algorithm and a Process Condition Monitoring (PCM) algorithm in order to execute a flow rate and concentration measurement mode suited for a field, to determine whether a process is normally running or not, and to perform operation and control related to measurement of a flow rate and a concentration;
a power supply portion that supplies power needed by the control portion and the sensor transception portion; and
an external output portion that outputs a concentration measured through the control portion to an external device.

2-3. (canceled)

4. The ultrasonic system for measuring both a flow meter and a concentration, according to claim 1, wherein the external output portion is connected to at least one external output unit selected from among a display output unit, a relay output unit, and an LED.

5. The ultrasonic system for measuring both a flow meter and a concentration, according to claim 1, wherein the PCM algorithm checks a process state, a pipe state, and a dispersion uniformity of SS, determines “run” or “stop” as a process operation state by collating results of the checking, and notifies an operator of information about measurement of in-process effective SS, the process operation state, and a pipe filling state (“full” or “empty”) by determining the dispersion uniformity of SS.

6. The ultrasonic system for measuring both a flow meter and a concentration, according to claim 1, wherein the PCM algorithm performs measurement modes including a Real Time (RT) mode in which a change in concentration is measured in real time according to an on-site operation pattern and a Process Monitoring (PM) mode in which a change in concentration is automatically measured only while a process is running, based on a result of PCM.

7. The ultrasonic system for measuring both a flow meter and a concentration, according to claim 1, wherein the unified signal processor further has an RF transmission function to enable telemetering.

8. The ultrasonic system for measuring both a flow meter and a concentration, according to claim 1, wherein the flow-metering ultrasonic sensor is provided as a module by using a dedicated transit-time(dT)-metering chip.
